(19) United States
(12) Patent Application Publication
(10) Pub. No.: US 2007/0035147 A1
(43) Pub. Date: Feb. 15, 2007

(54) Interconnectable profiled elements, in particular for panel-type structural components of motor vehicles

(75) Inventors: Joerg Burzer, Stuttgart (DE); Wolfgang Fussnegger, Tuebingen (DE); Tobias Hiermer, Sindelfingen (DE); Reiner Jost, Calw (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/549,178

(22) PCT Filed: Jan. 28, 2004
(86) PCT No.: PCT/EP04/00728

§ 371 Date: Aug. 9, 2006

(30) Foreign Application Priority Data
Mar. 18, 2003 (DE) 103117644

(51) Int. Cl. B62D 27/00

(52) U.S. Cl. 296/29

(57) ABSTRACT

Interconnectable profiled elements (1, 2), in particular for panel-type structural components of motor vehicles, having, on opposite joining edges, a respective projecting connecting web (3) and a respective recess (4), which peters out in open form into the relevant joining edge at a distance from this connecting web (3), for receiving the connecting web (3) of an attached profiled element (1, 2) having a joining edge of complementary design are intended to be joinable at different distances from one another. By this means, it is intended to be able to obtain an exact length measurement for a component joined together from a plurality of profiled elements.

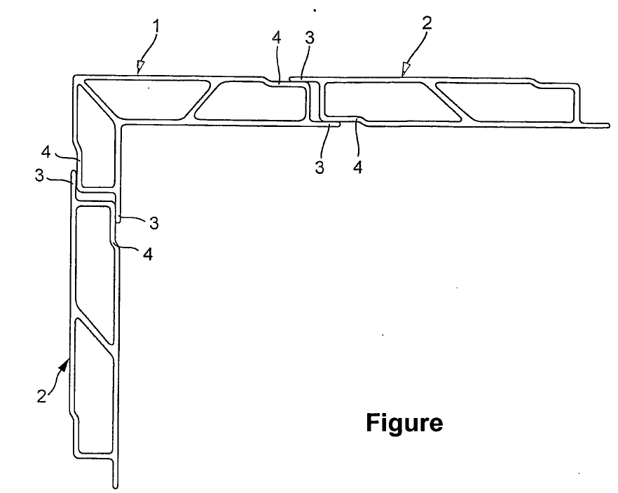

For this purpose, the webs (3) and recesses (4) are provided in a shape which permits the profiled elements (1, 2) which are to be connected to one another to be joined at different distances from one another within a predefinable range of tolerances.

### FIELD OF THE INVENTION

The invention relates to interconnectable profiled elements, in particular to panel-type structural components of motor vehicles.

### BACKGROUND AND SUMMARY OF THE INVENTION

DE 197 12 316 A1 discloses profiled elements. The joining edges are designed in such a manner that the individual profiled elements are in each case fitted to one another at a structurally predefined distance.

The invention is concerned with the problem of being able to join profiled elements to one another at different distances within a predefined range of tolerances and then to connect them to one another.

This problem is solved by profiled elements as described and claimed hereinafter.

According to the present invention, in a component in which a plurality of profiled elements are arranged on a row in one direction, the overall size of the component can be set exactly in the joining direction by a possible equalization in the joining regions between the individual profiled elements so as thereby not to have to tolerate any variations in size in the corresponding overall length of the component.

The profiled elements which are joined in an overlapping manner can be connected to one another preferably by welding.

The profiles themselves may be panel-type elements with a sandwich-like construction. In particular, the panel-type elements may have a type of honeycomb structure. The configuration according to the invention of the joining edges is of particular interest in the case of thin panel elements. In the case of motor vehicles, the profiled elements according to the invention can be used to form a simply designed supporting structure, as are described in various embodiments in DE 199 17 177 A1.

### BRIEF DESCRIPTION OF THE DRAWINGS

An exemplary embodiment is illustrated in the drawing, in the single FIGURE which shows a section through profiled elements joined to one another.

### DETAILED DESCRIPTION OF THE DRAWINGS

The FIGURE illustrates a component composed of a multiplicity of profiled elements. The component includes a corner profile 1 and a respective panel-type profiled element 2 adjoining it, which are connected to one another.

A respective projecting web 3 and, at a distance therefrom, a recess 4, which peters out in open form into the joining edge, are provided on the joining edges of the profiled elements 1, 2. The respectively attached profiled element 1, 2 in each case has a complementary shape in the relevant joining region in such a manner that the webs 3 can in each case be pushed onto the recesses 4. In this case, the recesses 4 and webs 3 are coordinated with one another in terms of shape in such a manner that, on the one hand, different overlapping regions are possible in the joining direction and that, on the other hand, the surfaces of the panel-type profiled elements come to lie in a common plane.

The design of the joining regions outlined very clearly shows that the individual profiled elements 1, 2 can be joined to one another at different distances merely by overlapping regions of different length being produced between webs 3 and recesses 4 by virtue of the design.

The joined profiled elements 1, 2 can be fixed in a very advantageous manner, for example by welds matched to the materials of the profiled elements.

Supporting structural parts which are composed of the profiled elements joined according to the invention can be used, in particular, extremely advantageously in the case of vehicle bodies, including supporting floor regions.

1. Interconnectable profiled elements, having, on opposite joining edges, a respective projecting connecting web and a respective recess, which peters out in open form into the relevant joining edge at a distance from this connecting web, for receiving the connecting web of an attached profiled element having a joining edge of complementary design, characterized in that the shape of the webs and recesses permits the profiled elements which are to be connected to one another to be joined at different distances from one another within a predefinable range of tolerances.

2. The interconnectable profiled elements as claimed in claim 1, wherein the overlapping webs (3) are welded to the respectively adjacent profiled elements (1, 2).

3. The interconnectable profiled elements as claimed in claim 1, wherein the profiled elements are joined to form a panel-type structural component of a motor vehicle.

4. A join for two interconnectable profiled elements, comprising a joining edge of one profiled element and a joining edge of the other profiled element, wherein each joining edge including a projecting connecting web and a recess that peters out in open form into the respective joining edge at a distance from the connecting web, wherein the recess of each joining edge is designed to receive the connecting web of the other joining edge, and wherein the webs and recesses of the joining edges allow the profiled elements to be joined at different distances from one another within a predefinable range of tolerances.

5. The join as claimed in claim 4, wherein the web of each profiled element's joining edge is welded to the other profiled element.

6. The join as claimed in claim 4, wherein the profiled elements are joined to form a panel-type structural component of a motor vehicle.
